(19) United States
(12) Patent Application Publication
(10) Pub. No.: US 2011/0130153 A1
(43) Pub. Date: Jun. 2, 2011

(54) Computerized Traveler Tracking

(75) Inventor: Stacey Michelle Davis, Forrest Hill, MD (US)

(73) Assignee: Safetrip Technologies, Inc.

(21) Appl. No.: 12/958,393

(22) Filed: Dec. 1, 2010

Related U.S. Application Data
(60) Provisional application No. 61/265,619, filed on Dec. 1, 2009.

(51) Int. Cl. H04W 64/00

(52) U.S. Cl. 455/456.1

(57) ABSTRACT

In one aspect, a method may be provided. The method may comprise creating a trip file in a database, the trip file corresponding to the trip and including traveler data corresponding to the plurality of travelers. The method may further comprise accessing the trip file from a mobile handheld device, the mobile handheld device to physically travel with the plurality of travelers on the trip. The method may further comprise checking-in the plurality of travelers by marking a traveler-present-indicator as present for each of the plurality of travelers that is physically present. The method may further comprise determining if any of the plurality of travelers is missing by comparing the traveler data and the checked-in plurality of travelers. The method may further comprise checking-out the plurality of travelers by unmarking the traveler-present-indicator for each of the plurality of travelers that is no longer physically present.

This application claims any benefit and priority of and to an earlier filed provisional application, filed Dec. 1, 2009, identified as Application No. 61/265,619.

### BACKGROUND OF THE INVENTION

1. Field of the Invention

Embodiments of the present invention relate generally to computer systems and, more particularly, to computerized traveler tracking.

2. Description of Related Art

A myriad of types of travelers may go on a myriad of types of trips. By way of non-limiting examples, a student may go on a school field trip, a camper may go on a Boy Scout camping weekend, a prisoner may be transported from a first to a second location, an elderly person may go on a day trip with an assisted living group, a patient may be transported to a tertiary care facility, and a child or children may attend an amusement park. In these and other cases, it may be desirable to track travelers on their trips. Therefore, there may be a need for improved traveler tracking.

### BRIEF SUMMARY OF THE INVENTION

According to an aspect of the invention, provided is a method of tracking a plurality of travelers on a trip, the method being executable on one or more processors. The method may comprise the operation of creating a trip file in a database, the trip file corresponding to the trip and including traveler data corresponding to the plurality of travelers. The method may further comprise the operation of accessing the trip file from a permanent or semi-permanent station containing a device or more typically a mobile handheld device, the mobile handheld device to physically travel with the plurality of travelers on the trip; provided that a handheld device may be incorporated into normal or typical consumer devices, such as smart phones (e.g., iPHONE, ANDROID, and BLACKBERRY) or into specialty devices, consumer, commercial, or otherwise. The method may further comprise the operation of checking-in the plurality of travelers by marking a traveler-present-indicator as present for each of the plurality of travelers that is physically present. The method may further comprise the operation of determining if any of the plurality of travelers is missing by comparing the traveler data and the checked-in plurality of travelers. The method may further comprise checking-out the plurality of travelers by unmarking the traveler-present-indicator for each of the plurality of travelers that is no longer physically present.

According to a second aspect of the invention, provided is a method of tracking a plurality of travelers on a trip. The method may be executable on one or more processors. The method may comprise the operation of accessing a trip file from a mobile handheld device, the trip file including traveler data. The method may further comprise the operation of checking-out the plurality of travelers to go on the trip by unmarking a traveler-present-indicator for each of the plurality of travelers that is no longer physically present. The method may further comprise the operation of checking-in the plurality of travelers by marking the traveler-present-indicator for each of the plurality of travelers that is physically present. The method may further comprise the operation of determining if any of the plurality of travelers is missing by comparing the traveler data and the checked-in plurality of travelers. The method may further comprise the operation of if any of the plurality of travelers is missing, broadcasting a missing traveler's information to a second mobile handheld device or to an administrative central location.

According to a third aspect of the invention, provided is a system to track a plurality of travelers during a trip. The system may comprise a main database comprising a trip file corresponding to the trip, the trip file including traveler data corresponding to the plurality of travelers. The system may further comprise a portable database including the trip file. The system may further comprise a mobile handheld device to physically travel with the plurality of travelers on the trip, the mobile handheld device in communication with the portable database. The mobile handheld device may be adapted to access the trip file. The mobile handheld device may be further adapted to check-in the plurality of travelers by marking a traveler-present-indicator as present for each of the plurality of travelers that is physically present. The mobile handheld device may be further adapted to determine if any of the plurality of travelers is missing by comparing the traveler data and the checked-in plurality of travelers. The mobile handheld device may be further adapted to check-out the plurality of travelers by unmarking the traveler-present-indicator for each of the checked-in plurality of travelers that is no longer physically present.

The foregoing and other aspects and advantages of the invention are illustrative of those that can be achieved by the various exemplary embodiments and are not intended to be exhaustive or limiting of the possible advantages which can be realized. For example, a system may be: adapted to check in/check out and manage travelers in a handheld database that syncs to a central database; modified such that travelers can be checked in/out via numerous modalities such as tapping of a name of the traveler on a screen, scanning a barcode of a traveler wristband or badge, or reading an RFID or calculating GPS proximity to a defined point; tailored to identify demographic and medical/special needs information stored on a device and via a pop-up alert, inform a traveler chaperone of special needs and medication administration times, as well as emergency contact info; personalized to conduct a real-time full audit trail derived from the continuous recordation of every event routine during a trip as well as retroactive reporting to of data to selected or remote databases; refined to allow interested parties of traveler (e.g., parents of students, and guardians of prisoners) to portal via the Internet (e.g., using an Application Service Provider (ASP) or other web-based modality or site) to determine GPS location, last medical administration, and other general or specialized trip information; customized to interface with secure main user's databases (e.g., school system); adapted to provide trip-status updates and notifications via multiple vehicles (e.g., portal, text, and auto-dialer tied to VOIP notification system of traveler database of organization; modified to give traveler pertinent data (e.g., photo of traveler on day of trip) for transmission to authorities with live validation or comparison to previously acquired said pertinent data; encoded to alert for incident tracking during trips; programmed to provide mid-trip or pre-determined periodic checks during a trip, resulting in notification routines of what, for example, a traveler has been ‘checked-in’ to return to an origination point of trip. Thus, these and other aspects and advantages of the various exemplary embodiments will be apparent from the description herein or can be learned from practicing the various exemplary embodiments, both as embodied herein or as modified in view of any variation which may be apparent to those skilled in the art.

### BRIEF DESCRIPTION OF THE DRAWINGS

FIG. 1 is a block diagram of a computerized traveler tracking system according to an embodiment of the present invention.

FIG. 2 is a flowchart of an exemplary method of tracking a plurality of travelers on a trip according to an embodiment of the present invention.

FIGS. 3-7 are exemplary schematic representations of screenshots associated with the method of FIG. 2.

FIG. 8 is a flowchart of an exemplary method of tracking a plurality of travelers on a trip according to an embodiment of the present invention.

FIGS. 9-16 are exemplary schematic representations of screenshots associated with the method of FIG. 2.

FIG. 17 is an exemplary schematic representation of an initial screenshot on a hand-held device that requires a trip director pin code to access the method of FIG. 2 initially or after a determined period of inactivity.

FIGS. 18-20 are exemplary schematic representations of screenshots associated with the method of FIG. 2.

FIGS. 21-22 are exemplary schematic representations of screenshots on a hand-held device that show where and when a traveler has been assigned to a trip and checked-in, both identified by color gradient variation (or other metrics or indices) associated with the method of FIG. 2.

FIGS. 23-25 are exemplary schematic representations of screenshots on a hand-held device that show where, when, and if, a traveler has been assigned to a specified vehicle trip associated with the method of FIG. 2.

FIGS. 26-28 are exemplary schematic representations of screenshots on a hand-held device that show a trip director confirming the presence (or lack thereof) of a traveler and an alert highlighting internal safety controls to ensure all travelers of a trip are identified associated with the method of FIG. 2.

FIGS. 29-30 are exemplary schematic representations of screenshots on a hand-held device that show a traveler getting checked-out of a trip associated with the method of FIG. 2.

FIG. 31 is an exemplary schematic representation of an identifying wristband associated with the method of FIG. 2

### DETAILED DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

As used in this application, the terms “a”, “an” and “the” may refer to one or more than one of an item. The terms “and” and “or” may be used in the conjunctive or disjunctive sense and will generally be understood to be equivalent to “and/or”. For brevity and clarity, a particular quantity of an item may be described or shown while the actual quantity of the item may differ. Features from an embodiment may be combined with features of another.

In accordance with an embodiment of the present invention, computerized traveler tracking may be provided. In one embodiment, a computerized traveler tracking system may be provided. The computerized traveler tracking system may include a main server, a laptop, and a plurality of handheld devices. The main server may be a computing device accessible at an origination facility such as a school. The main server may include Structured Query Language (SQL) software. The laptop and plurality of handheld devices may accompany a plurality of travelers (e.g., students and passengers) and one or more chaperones (e.g., teachers and drivers) on a trip (e.g., field trip and other modes of transportation, including a subway or a train). The main server and the laptop may include application software for, by way of non-limiting example, setting up trips, importing medical records and traveler data, and conducting administrative functions. The plurality of handheld devices may include client software. In another embodiment, some or all of the main server, laptop, and plurality of handheld devices may be replaced in whole or in part by an Application Service Provider (ASP) model. The computerized traveler tracking system may enable computerized methods and automated systems of tracking students on their trip. For example, students may be checked-in and tracked during their trip (e.g., checked-into a bus, and tracked during a school field trip). In another example, students may be checked out during their trip (e.g., checked out from camp to go on a canoe trip). Accordingly, improved traveler tracking may be provided.

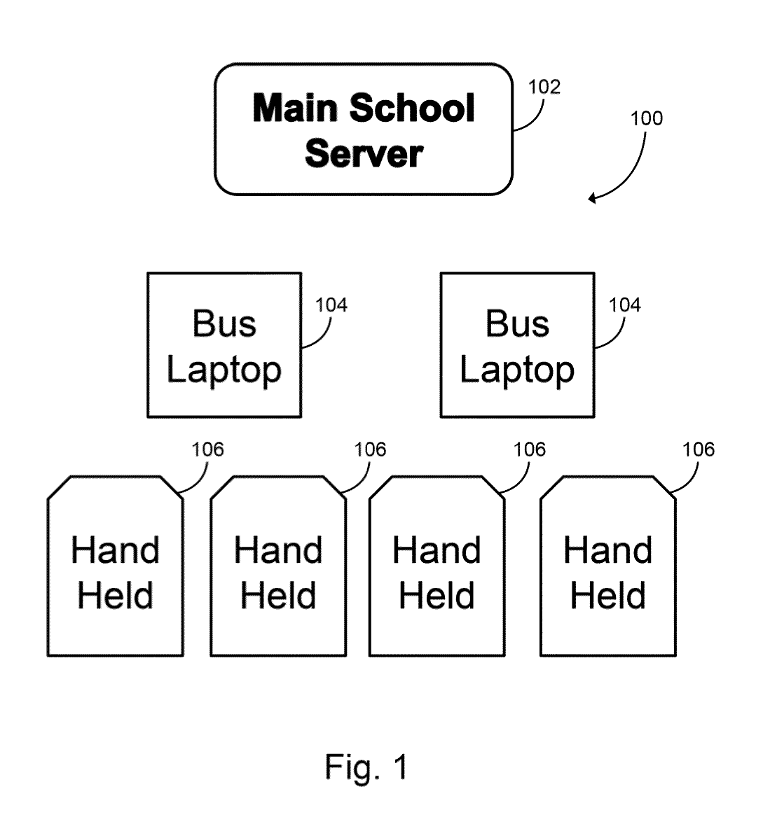

FIG. 1 is a block diagram of a computerized traveler tracking system 100 according to an embodiment of the present invention. The computerized traveler tracking system 100 may include a main school server 102, a plurality of bus laptops 104, and a plurality of handheld devices 106. Although one main school server 102, two bus laptops 104, and four handheld devices 106 are shown, a greater or lesser number of main school servers 102, bus laptops 104, and handheld devices 106 may be used. The main school server 102 may be in selective communication with the plurality of bus laptops 104. The plurality of bus laptops 104 may be in selective communication with the plurality of handheld devices 106.

In an embodiment, the computerized traveler tracking system 100 may include a barcode reader or other identifying and marking mechanism. In a second embodiment, the computerized traveler tracking system 100 may include a radio frequency identification RFID reader. In third and fourth embodiments, the computerized traveler tracking system 100 may include, respectively, a barcode reader and an RFID reader, or neither a barcode reader or an RFID reader.

The main school server 102 may include a main school database. The main school server 102 may include routines. Routines of the main school server (and the plurality of bus laptops 104 and the plurality of handheld devices 106) are introduced in the order herein only for the sake of the disclosure. The routines may be used at different times relative to their introduction in this disclosure. That is, the routines are not necessarily operative only in the order discussed. As noted above, routines from an embodiment may be combined with each other, and with routines of another.

The main school server 102 may include a login routine. The login routine may log a user into the main school server 102. The main school server 102 may include an audit-trial routine. The audit-trail routine may, in the system 100, create an audit trail of what each user does on the main school server 102.

The main school server 102 may include a create-trip routine. The create-trip routine may, in the system 100, create a trip. By way of non-limiting examples, each trip may include a title, date, sponsor, number of chaperones, and destination. The main school server 102 may include a load-travelers routine. The load-travelers routine may, in the system 100, load travelers from the main school database 102 who will go on the trip. The main school server 102 may include an assign-traveler routine. The assign traveler routine may, in the system 100, assign a traveler to a chaperone and to a buddy. The main school server 102 may include a generate-wristband routine. The generate-wristband routine may, as part of the system 100, generate wristbands (or other items) for travelers and chaperones. By way of non-limiting example, in a barcode reader embodiment, a wristband (or a card, a sticker, or an item) may be printed out to include a barcode thereon. A traveler may wear the wristband and may be, for example, checked-in via scanning of the barcode. By way of a second non-limiting example, in an RFID embodiment, a wristband (or a card or a device) including an RFID device may be initialized. A traveler may wear the wristband and may be, for example, checked-in via reading of the RFID device by either an active or a passive RFID reader. In the main school server 102 may include an emergency-communication routine. The emergency-communication routine may, as part of the system 100, email (e.g., email and text) defined people within an organization (e.g., a school district administration) in case of an emergency. By way of non-limiting example, if a bus is involved in an automobile accident and a trip is delayed, people at the school district administration may be contacted so that administrators can take appropriate action. As with one or more of the communication routines, the emergency-communication routine may enable bilateral or multilateral communication, not just, for example, to, but also from defined people within the organization. The main school server 102 may include an emergency-contact-communication routine. The emergency-contact-communication routine may, as part of the system 100, transmit data en masse to travelers' emergency contacts. The main school server 102 may include a reporting routine. The reporting routine may, as part of the system 100, generate reports. By way of non-limiting example, the reporting routine may provide a trip summary including late travelers, emergencies, buddy reassignments, and any trip incidents.

The plurality of bus laptops 104 may include bus databases. A bus laptop 104 may include routines. A bus laptop 104 may include a login routine. The login routine may log a user into a laptop 104. A bus laptop 104 may include a transmit-bus-database routine. The transmit-bus-database routine may transmit a bus database (or data therein such as trip data and final trip data) to the main school server 102. A bus laptop 104 may include a notify-traveler-contact routine. The notify-traveler routine may, as part of the system 100, communicate information to a group going on a trip. By way of non-limiting examples, a text message may be sent to each cell phone number on file or an email to a email address according to pre-defined settings (as part of the traveler demographic data discussed herein) for each boy on a Boy Scout field trip when the trip bus has arrived at an out of state campground, or a group of parents may be notified when a Boy Scout bus is within 60 minutes of an agreed upon pickup location. A bus laptop 104 may store and transmit photos of travelers.

A handheld device 106 may, by way of non-limiting example, be a phone-enabled Windows Mobile OS handheld device. A handheld device 106 may include routines. Routine displays may include features large enough to be selected with an index finger. A handheld device 106 may include a login routine. The login routine may log a user into the handheld device 106. By way of non-limiting example, in a barcode reader embodiment, the login routine may read an employee badge including a barcode in conjunction with a login. A handheld device 106 may include a phone-dialer routine. The phone-dialer routine may dial a phone number of a displayed contact or contact phone number upon tapping on that contact or contact phone number. A handheld device 106 may include a communication routine. The communication routine may, as part of the system 100, communicate (e.g., email, text-message, or telephone with a digital voice message) information to a single person or a group. By way of non-limiting example, a communication stating “We won the football championship 13-3” may be text-messaged to all parents of children attending a particular school. By way of a second non-limiting example, a communication that a group on a field trip is delayed 90 minutes in traffic may be text-messaged to some parents and telephoned as a digital voice message to other parents, depending on parent preferences.

A handheld device 106 may include a load-trip routine. The load-trip routine may load a trip created via the main school server 102. A handheld device 106 may include a vehicle-identification routine. The vehicle-identification routine may, in the system 100, identify a vehicle (e.g., a bus) for use with a trip. By way of non-limiting example, in a barcode reader embodiment, a barcode may be assigned to a particular vehicle. The vehicle-identification routine may be used to scan the barcode of the particular vehicle. By way of a second non-limiting example, in an embodiment having neither a barcode reader nor an RFID reader, a particular vehicle may be identified via manual entry (e.g., by entering a license plate number of the vehicle, or a phone number of the operator of the vehicle into the system 100). A handheld device 106 may include an assign-traveler routine. The assign-traveler routine may, in the system 100, assign a traveler to a chaperone and to a buddy. A handheld device 106 may include an edit-trip routine to, in the system 100, modify information entered in the create-trip routine of the main school server 102. A handheld device 106 may include a wristband-reprint routine. The wristband-reprint routine may, as part of the system 100, reprint selected traveler wristbands. A handheld device 106 may include an assign-chaperone routine. The assign-chaperone routine may, in the system 100, assign a chaperone to a particular bus (or other vehicle). By way of non-limiting example, in a barcode reader embodiment, a chaperone may be issued a barcode (e.g., a wristband, a card, or an item having a barcode thereon) and the particular bus may be issued a barcode (e.g., a sticker, a card, or an item having a barcode thereon). By scanning the chaperone and then the particular bus, the chaperone may be assigned to the particular bus. By way of a second non-limiting example, in an RFID embodiment, a chaperone may be issued an RFID device (e.g., a wristband, a card, or a device including an RFID device therein) and the particular bus may be issued an RFID device (e.g., an RFID reader). By scanning the chaperone with the RFID device of particular bus, the chaperone may be assigned to the particular bus. By way of a third non-limiting example, in a barcode and RFID embodiment, a chaperone may be issued an RFID device and the particular bus may be issued a bar code. By scanning the chaperone with an RFID reader and the particular bus with a barcode reader, the chaperone may be assigned to the particular bus.

A handheld device 106 may include a traveler-check-in routine. The traveler-check-in routine may, in the system 100, check-in travelers to a particular bus. By way of non-limiting example, in a barcode reader embodiment, a student may be issued a barcode and the particular bus may be issued a barcode. By scanning the student and then the particular bus when the student boards the bus, the student may be checked-in. By way of a second non-limiting example, in an RFID embodiment, a student may be issued an RFID device and the particular bus may be issued an RFID device. By scanning (either actively or passively) the student with the RFID reader when the student boards the bus, the student may be checked-in. By way of a third non-limiting example, in an embodiment having neither a barcode reader nor an RFID reader, a student may be manually checked-in (e.g., by taping on the student's name on a handheld device 106) when the student boards the bus. A handheld device 106 may import pictures of travelers from standard files, and may capture photos of travelers before/during/after a trip (e.g., as a traveler boards a bus).

A handheld device 106 may include a traveler-check-out routine similar to the traveler check-in routine. The traveler check-out routine may reflect, in the system 100, travelers who have departed. By way of non-limiting examples, a traveler may depart a camp site with a group for a day canoe trip, or may depart a bus during a trip to go into a restaurant. Thereafter, a traveler may be checked-in using the traveler-check-in routine.

A handheld device 106 may include a missing-travelers routine. The missing-travelers routine may, in the system 100, show travelers who are missing. By way of non-limiting example, checked-in travelers may be compared, with names of the travelers identified using the load-travelers routine of the main school server 102. Any travelers identified using the load travelers routine that are not checked-in may be indicated in the system 100 as missing. A handheld device 106 may include a manual-missing-routine. The manual-missing routine may allow a user to, in the system 100, manually identify a missing traveler. A handheld device 106 may include an allowed-missing routine. The allowed-missing routine may permit travelers to be indicated as missing in the system 100. By way of non-limiting example, if a traveler is sick, in detention (and thus not able to attend), or does not show up, the allowed-missing routine may enable the traveler to be indicated as such. A handheld device 106 may include an enter-new-traveler routine. The enter-new-traveler routine may allow a user to, in the system 100, identify new travelers not entered in the load-travelers routine of the main school server 102. A handheld device 106 may include a broadcast-missing-traveler routine. The broadcast-missing-traveler routine may, in the system 100, broadcast information (e.g., name and photo) about a missing traveler system wide and beyond via, by way of non-limiting example, text messaging cell phones. A handheld device 106 may include a communicate-departure-list routine. The communicate-departure-list routine may communicate an official departure list to a bus laptop 104, which may then communicate the official departure list to the main school server 102. A handheld device 106 may include a missing traveler-geolocator routine. The missing traveler-geolocator routine may communicate to a bus laptop the geographical location of a missing traveler via his wristband. As with some or all of the remaining data, the geographical location of travelers may be secured and only accessible via, for example, appropriate users having appropriate permissions.

A handheld device 106 may include a reassign-traveler routine. The reassign-traveler routine may, in the system, reassign travelers to a new bus mid-trip. The reassign-traveler routine may track the reason (or problem) requiring the reassignment. The reassign-traveler routine may enable checking in the reassigned traveler to the new bus. By way of non-limiting example, in a barcode reader embodiment, by scanning the student and then the new bus, the student may be reassigned. A handheld device may include transmit-trip-data routine. The transmit-trip-data routine may transmit data to a bus laptop 104, which may then transmit trip data to the main school server 102. By way of non-limiting example, the transmit trip data routine may transmit data regarding emergencies or late trips.

A handheld device 106 may include a retrieve-traveler-info routine. The retrieve-traveler-info routine may, in the system 100, bring up traveler demographic data. The traveler demographic data may be broken down into varying categories including emergency contact information, health information, and traveler contact information. Health information may include discrete health data (e.g., disease, asthma, allergies, and prescription histories) and full health records (e.g., physician notes and lab results). A handheld device 106 may include a traveler-return check-in routine. The traveler-return check-in routine may, in the system 100 recheck-in a student. By way of non-limiting example, in a barcode reader embodiment, by scanning a student and a particular bus, a student may be checked-in upon return to the particular bus for returning home, or to a second destination. By way of a second non-limiting example, in an RFID embodiment, the plurality of handheld devices 106 may include an RFID-ready routine. The RFID-ready routine may ready an RFID reader to read an RFID device. The RFID-ready routine may be used when appropriate, including by way of non-limiting example, before the traveler-return check-in routine. By way of a third non-limiting example, in an embodiment having neither a barcode reader nor an RFID reader, a student may be manually checked-in (e.g., by taping on the student's name on a handheld device 106) upon return to the particular bus for returning home, or to a second destination.

A handheld device 106 may include an add-stop routine. The add-stop routine may, in the system 100, add a stop during a trip. By way of non-limiting example, the add-stop routine may add a second destination. It is again noted that routines may be used at different times. By way of non-limiting example, the missing-travelers routine may be used after the traveler return check-in routine to show travelers who may have gone missing during the trip, and the retrieve-traveler routine may be used to bring up traveler demographic data for any missing traveler. A handheld device 106 may include a transmit-final-trip data routine. The transmit-final-trip routine may transmit final trip data to a bus laptop 104, which may then transmit the final trip data to the main school server 102. A handheld device 106 may include an incident-tracker routine. The incident-tracker routine may, in the system 100, track incidents that may occur and actions that may need to be taken, for example, at the origination facility. A handheld device 106 may include a guardian-pickup routine. The guardian-pickup routine may reflect in the system 100 who took a student off of the origination facility's property. By way of non-limiting examples, the guardian pickup routine may reflect in the traveler tracking system 100 that a mother or a father picked up the student, or that a student was realized to the student's normal school bus to go home.

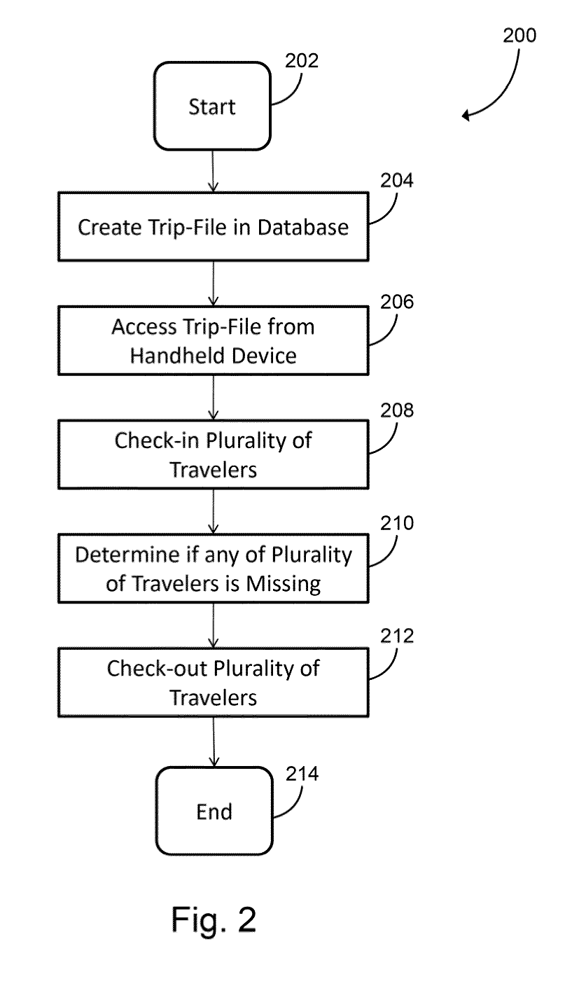

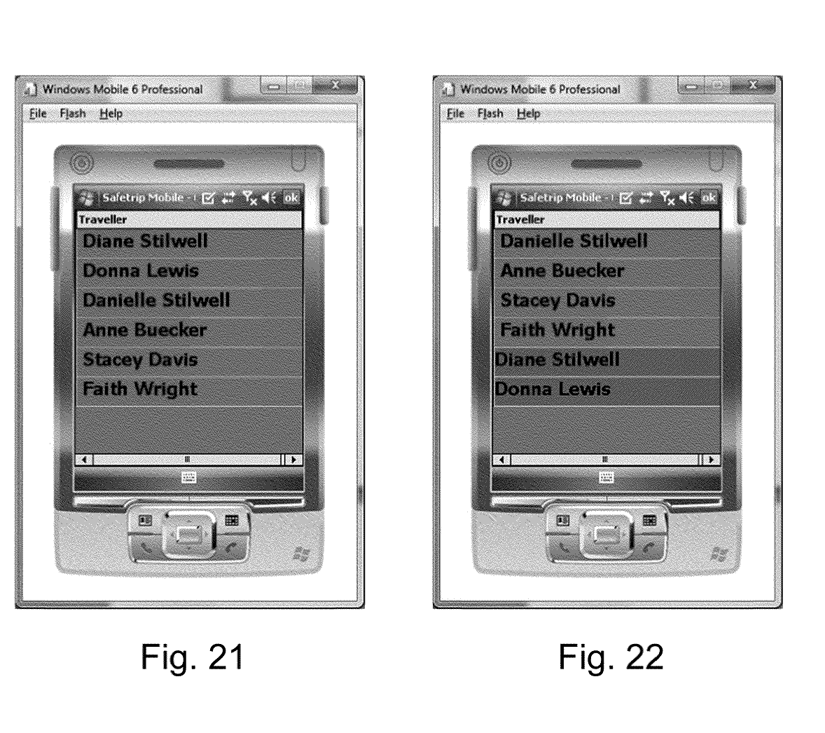

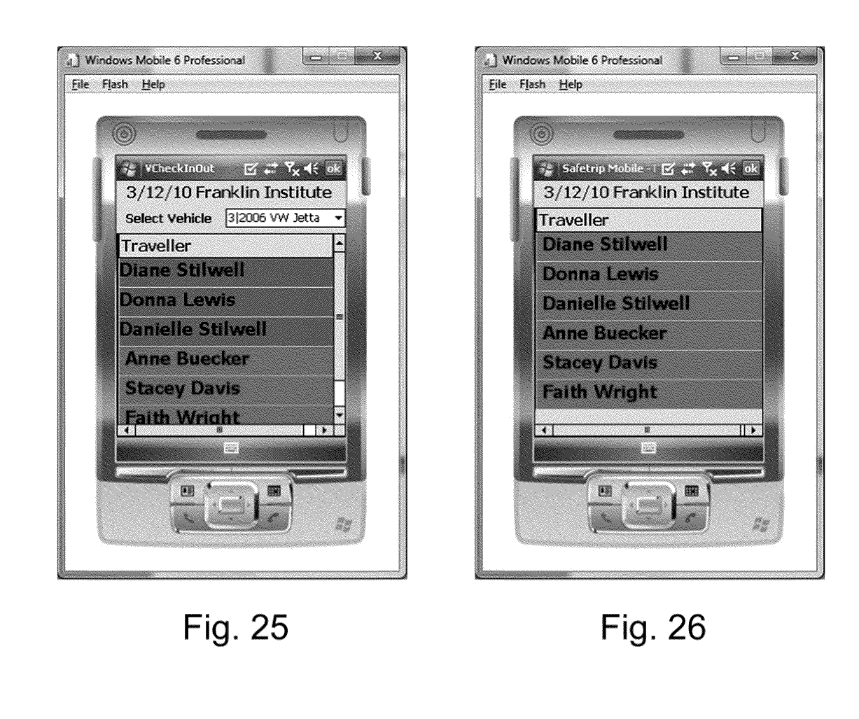

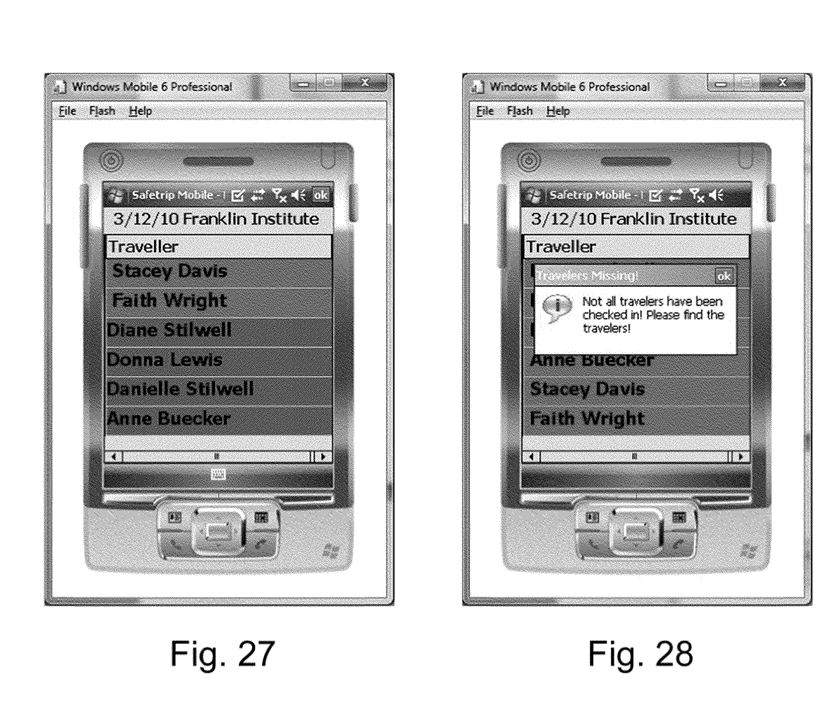

The operation of the computerized traveler tracking system 100 is now described with reference to FIGS. 2-8 and 9-30, which illustrate, inter alia, exemplary methods of tracking a plurality of travelers on a trip.

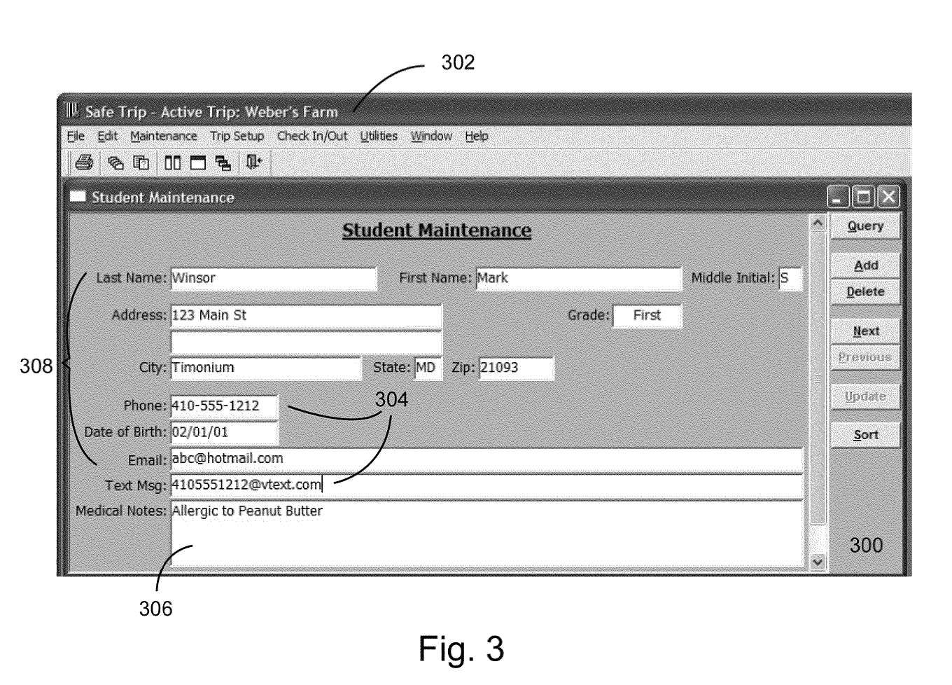

FIG. 2 is a flowchart of an exemplary method 200 of tracking a plurality of travelers on a trip according to an embodiment of the present invention. FIGS. 3-7 and 9-30 are schematic representations of screenshots associated with the method 200. The method 200 may be executable on one or more processors.

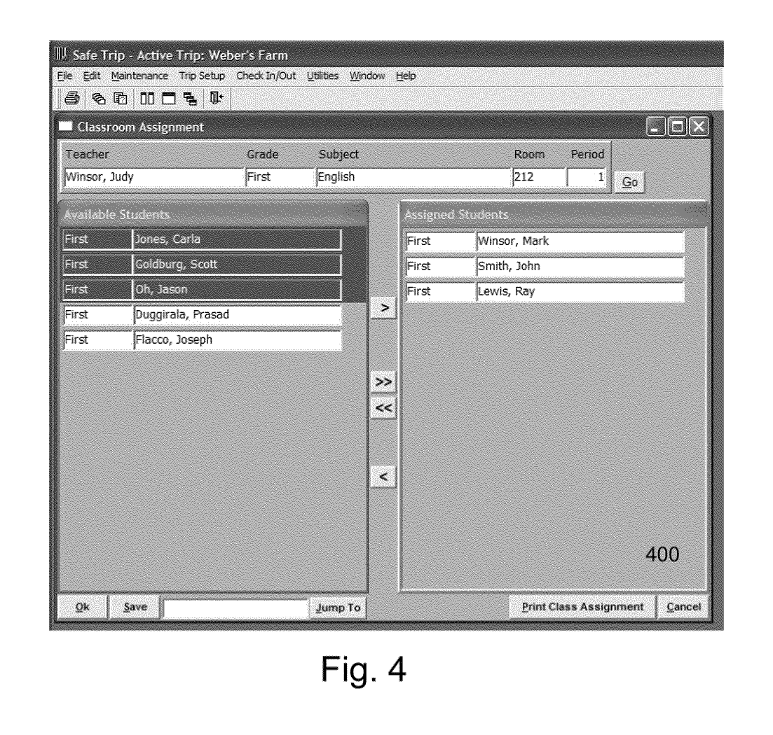

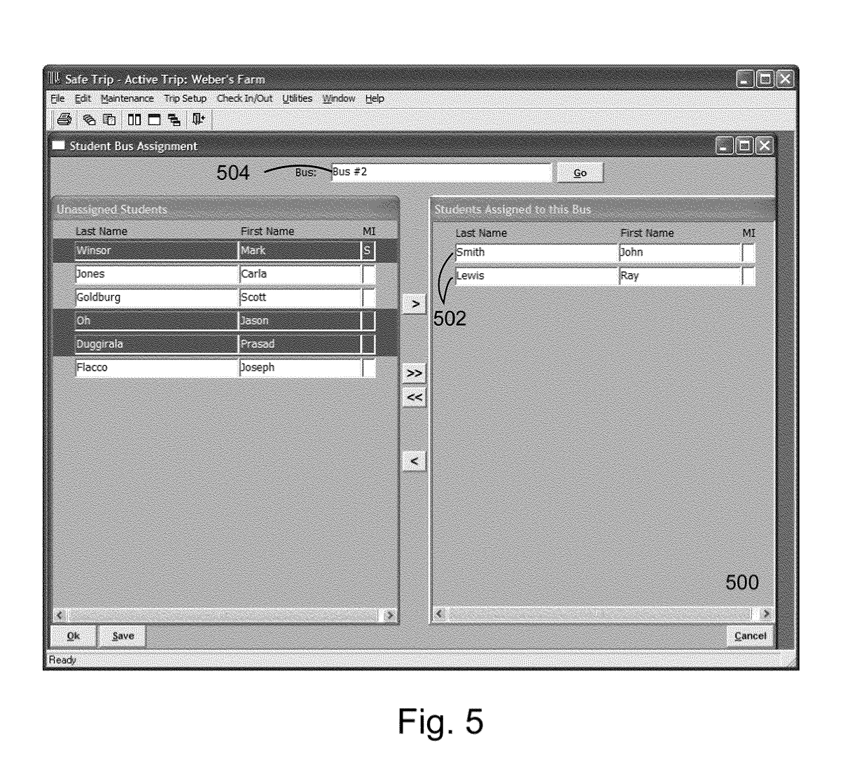

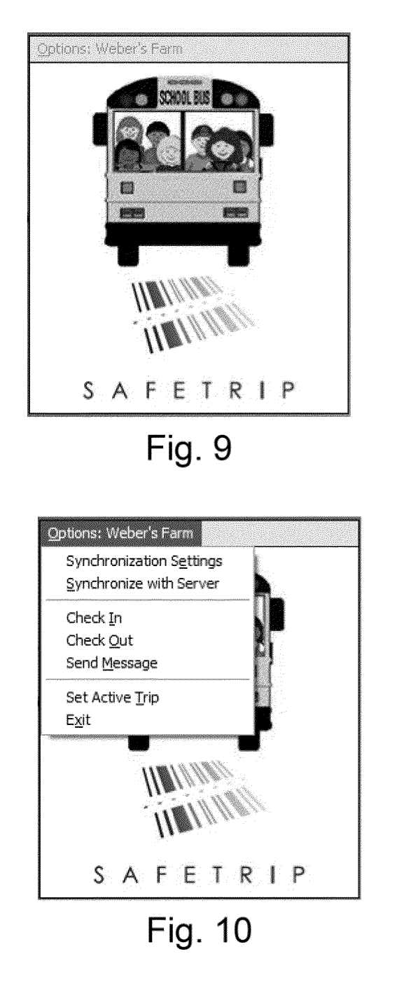

In operation 202, the method 200 may start (FIG. 9). In operation 204, a trip file may be created in a database. The trip file may correspond to a trip and may include traveler data corresponding to a plurality of travelers to go on the trip. By way of non-limiting example, a user may use the create-trip routine of the main school server 102 to create the trip file. The trip file may include a title, a date, a sponsor, a number of chaperones, and a destination. FIG. 3 is a schematic representation of a screen shot of a student maintenance screen 300 according to an embodiment of the present invention. In the student maintenance screen 300, data from the trip file (the destination 302) may be displayed. In the student maintenance screen 300, a traveler's (e.g., a student's) demographic data may be entered. The traveler demographic data may include emergency contact information 304, health information 306, and traveler contact information 308. FIG. 4 is a schematic representation of a screen shot of a classroom assignment screen 400 according to an embodiment of the present invention. The classroom assignment screen 400 may be used to assign students from a particular class to a trip. FIG. 5 is a schematic representation of a screen shot of a student bus assignment screen 500 according to an embodiment of the present invention. The student bus assignment screen 500 may be used to assign particular students to a particular bus. By way of non-limiting example, students 502 may be assigned to Bus No. 2 504.

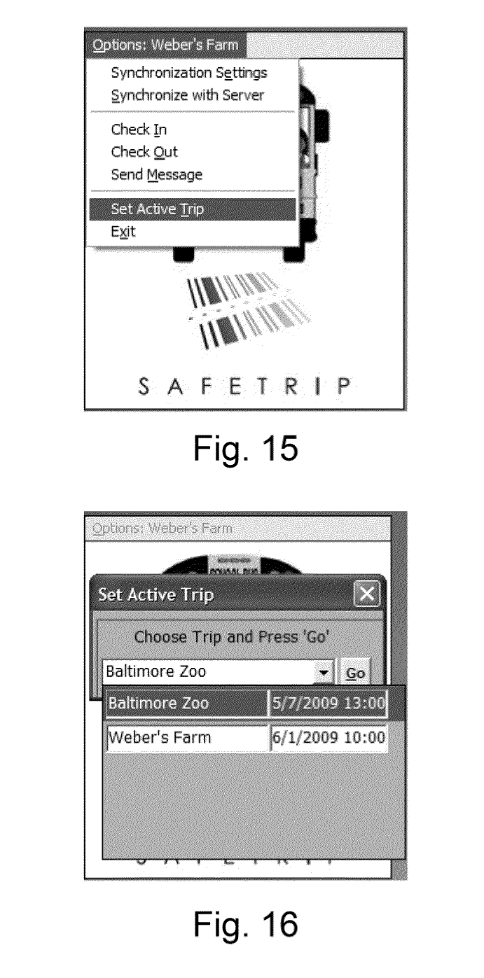

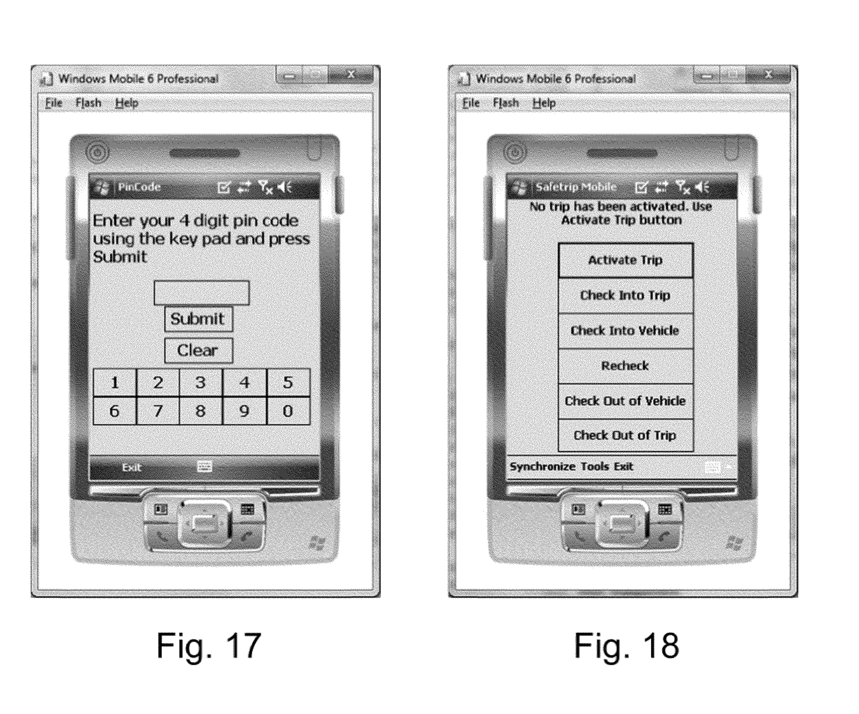

Turning back to FIG. 2, in operation 206, the trip file may be accessed using a mobile handheld device (FIGS. 15-30). The mobile handheld device may physically accompany the plurality of travelers on the trip. By way of non-limiting example, a user (e.g., a chaperone), may use the load-trip routine of the handheld device 106 to access the trip file created by the main school server 102. By way of non-limiting example, a user (e.g., a temporary guardian), may access an operation by using a pin code (FIG. 17) and accessing any number of operations (FIG. 18).

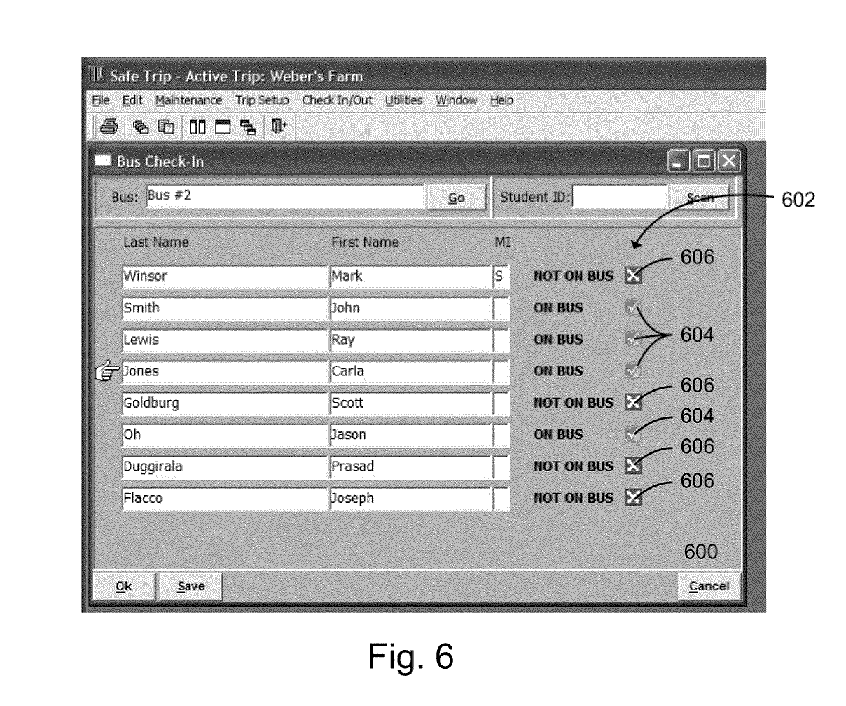

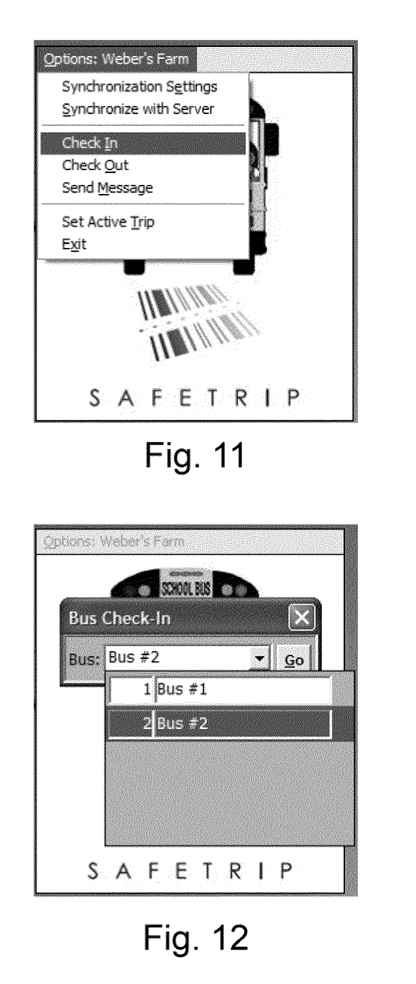

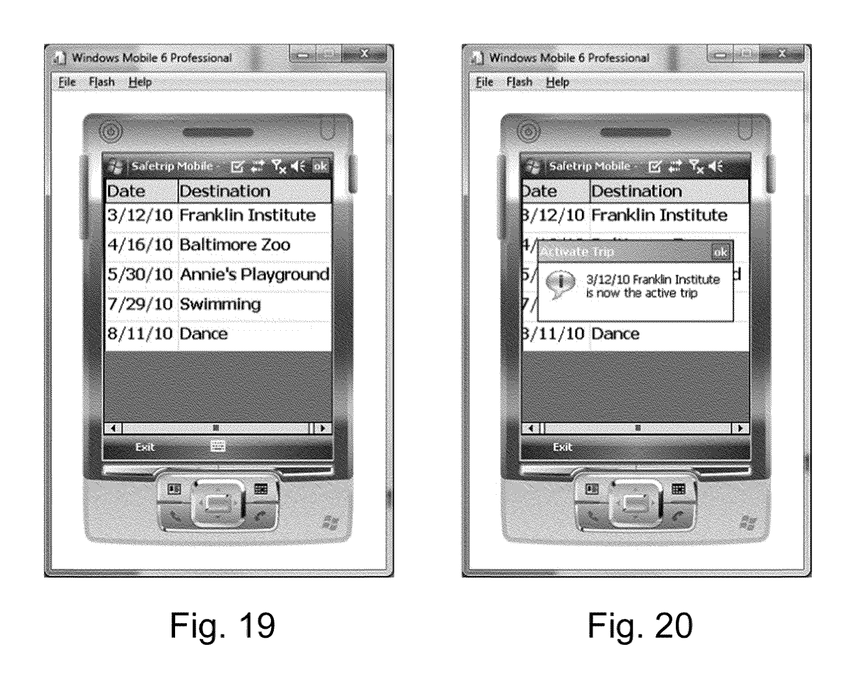

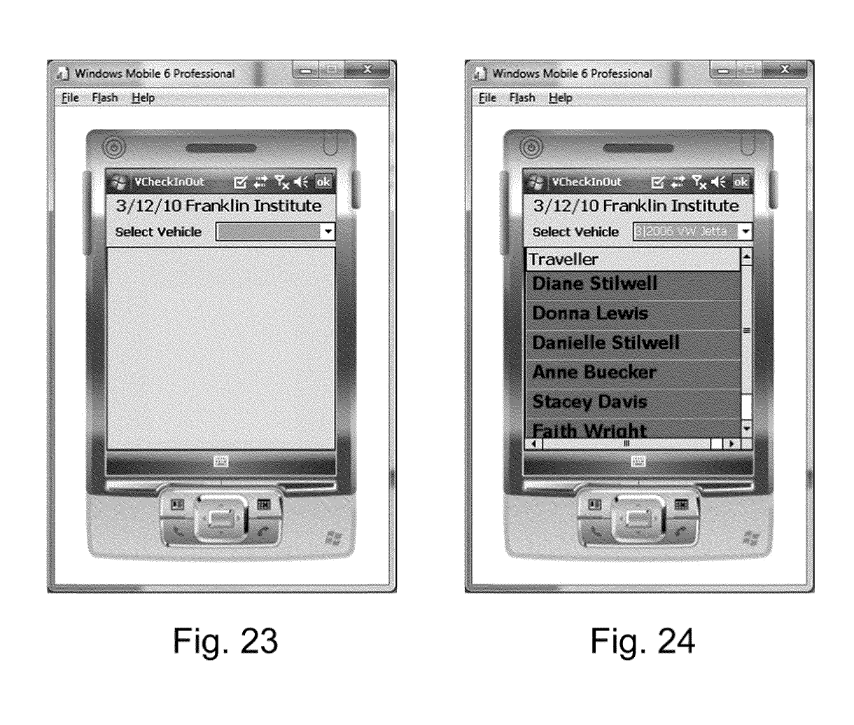

In operation 208, the plurality of travelers may be checked-in on the day of the trip (FIGS. 10-11; 21-23) by selecting a particular trip (FIGS. 19-20). The plurality of travelers may be checked-in by marking a traveler-present-indicator as present for each of the plurality of travelers that is physically present. By way of non-limiting example, the traveler-check-in routine of the handheld device 106 may be used to check-in travelers (e.g., students) to a particular bus (FIG. 12) or vehicle (FIGS. 23-25). In a barcode reader embodiment, a student may be issued a barcode and the particular bus may be issued a barcode. By scanning the student and then the particular bus when the student boards the bus, the student may be checked-in using an exemplary wristband (FIG. 31). In an RFID embodiment, the student may be issued an RFID device and the particular bus may be issued an RFID device. By scanning (either actively or passively) the student with the RFID reader when the student boards the bus, the student may be checked-in. In an embodiment having neither a barcode reader nor an RFID reader, a student may be manually checked-in (e.g., by taping on the student's name on a handheld device 106) when the student boards the bus. FIG. 6 is a schematic representation of a screen shot of a bus check-in screen 600 according to an embodiment of the present invention. In the bus check-in screen 600, a student present indicator 602 may be marked as present 604 for students who have checked-in, and not-present 606 for students who have not checked-in.

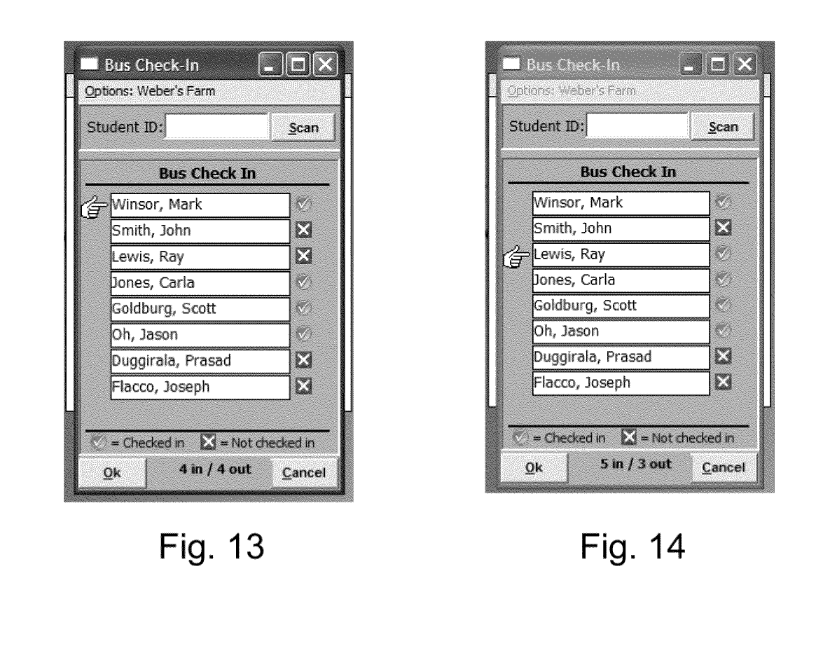

In operation 210, a determination may be made whether any of the plurality of travelers is missing (FIGS. 13-14; 26-28). The determination of whether any of the plurality of travelers is missing may be made by comparing the traveler data and the checked-in plurality of travelers. By way of non-limiting example, the missing-travelers routine of the handheld device 106 may be used to show travelers who are missing.

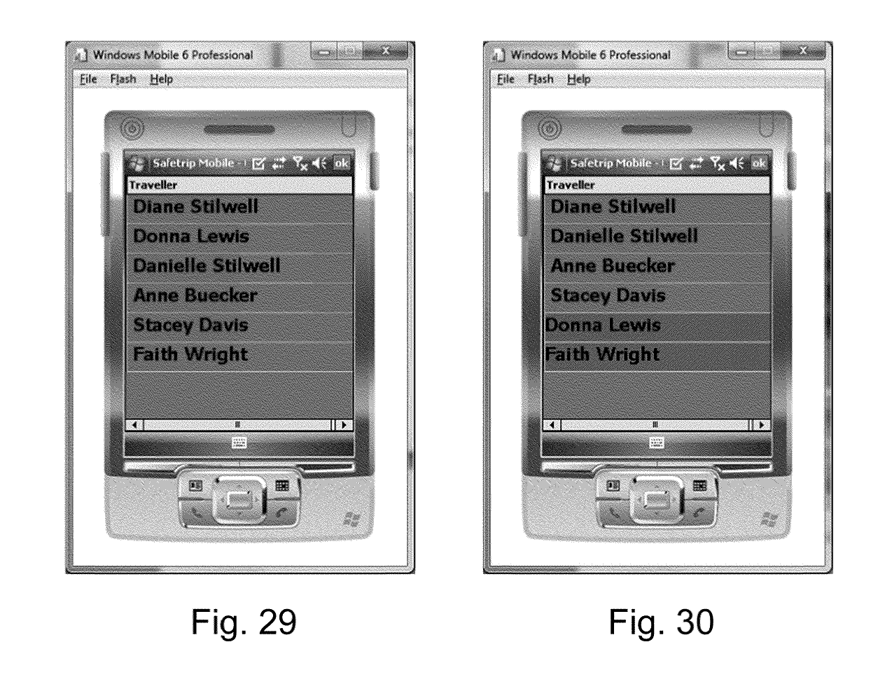

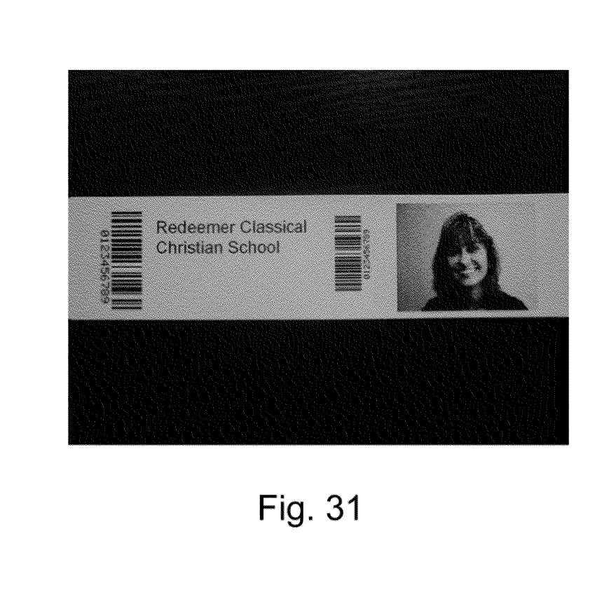

In operation 212, the plurality of travelers may be checked-out (e.g., during a trip outing, or after the trip) (FIG. 29-30). The plurality of travelers may be checked-out by unmasking the travel-present-indicator for each of the plurality of travelers that is no longer physically present (e.g., that has departed the bus). By way of non-limiting example, the guardian-pickup routine of the handheld device 106 may be used to reflect in the system that a father has picked up a student after the trip.

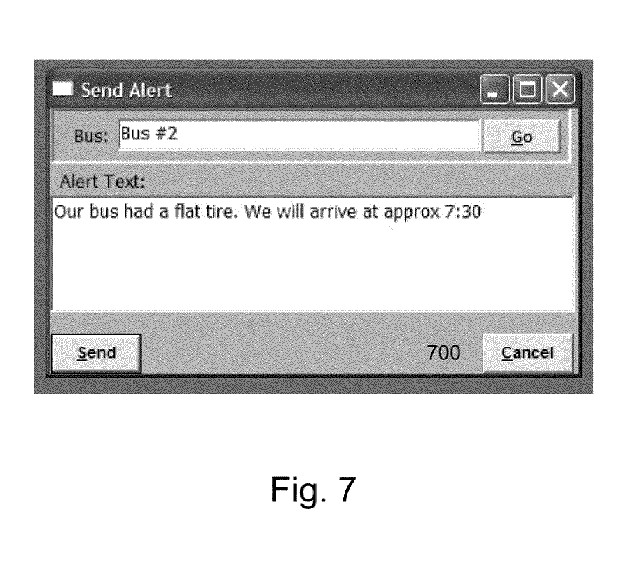

During the trip, trip information may be communicated. By way of non-limiting example, the communication routine of the handheld device 106 may be used to communicate with parents of students. FIG. 7 is a schematic representation of a send alert screen to send such a communication. A communication that a group on a field trip is delayed 90 minutes due to a flat tire may be text-messaged to some parents and telephoned as a digital voice message to other parents, depending on parent preferences.

In operation 214, the method may end.

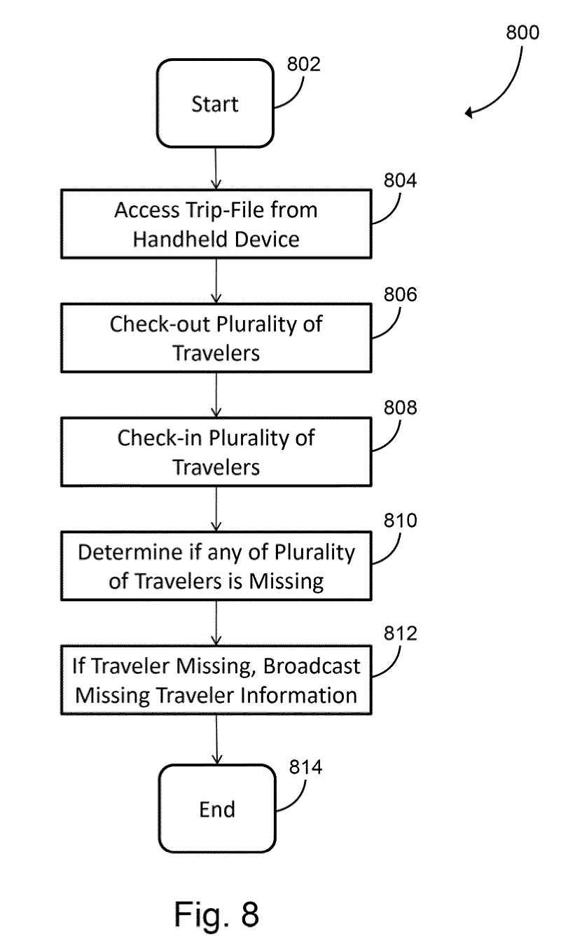

FIG. 8 is a flowchart of an exemplary method 800 of tracking a plurality of travelers on a trip according to an embodiment of the present invention. The method 800 may be executable on one or more processors.

In operation 802, the method may start. In operation 804, a trip file may be accessed using a mobile handheld device 106. By way of non-limiting example, a user (e.g., a chaperone), may use the load-trip routine of the handheld device 106 to access a trip file created by the main school server 102.

In operation 806, a plurality of travelers may be checked-out (e.g., during a canoe trip leaving from a camp). The plurality of travelers may be checked-out by unmarking a travel-present-indicator for each of the plurality of travelers that is no longer physically present (e.g., that has departed to go on the canoe trip).

In operation 808, the plurality of travelers may be checked-in upon returning from their trip. The plurality of travelers may be checked-in by marking a traveler-present-indicator as present for each of the plurality of travelers that is physically present. By way of non-limiting example, the traveler-check-in routine of the handheld device 106 may be used to check-in travelers (e.g., students) to camp.

In operation 810, a determination may be made whether any of the plurality of travelers is missing. The determination of whether any of the plurality of travelers is missing may be made by comparing the traveler data and the checked-in plurality of travelers. By way of non-limiting example, the missing-travelers routine of the handheld device 106 may be used to show travelers who are missing.

In operation 812, if a traveler is determined to be missing, that traveler's information may be broadcast. By way of non-limiting example, a user (e.g., a chaperone) may use the broadcast-missing-traveler routine of the handheld device 106 to broadcast information (e.g., a name and a photo) about a missing traveler system 100 wide and beyond, via, by way of non-limiting example, text messaging cell phones.

In operation 814, the method may end.

Although embodiments of the present invention have been shown and described, it would be appreciated by those skilled in the art that changes may be made in these embodiments without departing from the principles and spirit of the invention. By way of non-limiting example, although an RFID reader is not explicitly discussed with respect to the vehicle identification routine, one skilled in the art may appreciate that an RFID reader may be used with the vehicle identification routine. That is, features from one embodiment may be combined with features of another. By way of a second non-limiting example, although the communicate-departure-list routine is discussed with reference to communicating an official departure list to a bus laptop 104, and then to a main school server 102, one skilled in the art may appreciate that a departure list may be communicated to a main school server 102. That is, the data-flows may be modified. By way of a third non-limiting example, although the embodiments discuss students going on a school field trip from a school, the scope of the invention may encompass many different types of “travelers” and “trips”. By way of non-limiting examples, the invention may encompass campers going on a camping weekend, a prisoner being transported from a first to a second location, an elderly person going on a day trip with an assisted living group, participants participating in an event, and members belonging to a group. That is, the terms “travelers” and “trips” may be broadly interpreted. By way of a fourth non-limiting example, although the embodiments discuss computerized tracking, the scope of the invention may encompass many different types of “computerized” functions. That is, the term “computerized” may be broadly interpreted to include computerized or other systems employing automated technology. By way of a fifth non-limiting example, although an operating system or other system architecture may refer to Windows Mobile, for example, one of ordinary skill in the art would appreciate the use of any type of operating system that may control the invention in any type of device. By way of a sixth non-limiting example, although the invention contemplates a user of a handheld device located in a semi-permanent or permanent location obtaining real-time data from a database and an administrative user remote from the handheld device being able to obtain real-time data from the continuously updated handheld device, one of ordinary skill in the art would appreciate the incorporation of software or any other means to help a user assimilate (or disseminate) said real-time data. Accordingly, in view of the changes that may be made to the disclosed embodiments, the scope of the invention is defined in the claims and their equivalents and not limited to the embodiments shown and described.

What is claimed is:

1. A method of tracking a plurality of travelers on a trip, the method comprising:
creating a trip file in a database, the trip file corresponding to the trip and including traveler data corresponding to the plurality of travelers;
accessing the trip file from a device;
checking-in the plurality of travelers using the device by marking a traveler-present-indicator as present for each of the plurality of travelers that is physically present;
determining if any of the plurality of travelers is missing using the device by comparing the traveler data of the trip file and the marked traveler-present-indicators of each of the plurality of travelers that are physically present; and
checking-out the plurality of travelers using the device by unmarking the traveler-present-indicator for each of the plurality of travelers that is no longer physically present.

2. The method of claim 1, wherein the device is contained within either a permanent or semi-permanent station.

3. The method of claim 1, wherein the device is a mobile handheld device.

4. The method of claim 4, wherein the mobile handheld device is a smartphone.

5. The method of claim 1, wherein the checking in of the plurality of travelers and the checking-out of the plurality of travelers further comprises at least one member of the group consisting of touching on a traveler's name on the device, scanning a bar code corresponding to a traveler, sensing a radio-frequency identification corresponding to a traveler, and sensing a presence of a traveler using a global positioning system location indication.

6. A method of tracking a plurality of travelers on a trip, the method comprising:
accessing a trip file from a mobile handheld device, the trip file including traveler data;
checking-out the plurality of travelers to go on the trip using the mobile handheld device by unmarking a traveler-present-indicator for each of the plurality of travelers that is no longer physically present;
checking-in the plurality of travelers using the mobile handheld device by marking the traveler-present-indicator for each of the plurality of travelers that is physically present;
determining if any of the plurality of travelers is missing using the mobile handheld device by comparing the traveler data of the trip data and marked traveler-present-indicators of each of the plurality of travelers that are physically present; and
if any of the plurality of travelers is missing, broadcasting, from the mobile handheld device, a missing traveler's information to a remote device.

7. The method of claim 6, wherein the mobile handheld device is contained within either a permanent or semi-permanent station.

8. The method of claim 6, wherein the mobile handheld device is a smartphone.

9. The method of claim 6, wherein the remote device is either a second mobile handheld device or an administrative central location device.

10. The method of claim 6, wherein the remote device is a smartphone.

11. The method of claim 6, wherein the checking-out of the plurality of travelers and the checking-in of the plurality of travelers further comprises at least one member of the group consisting of touching on a traveler's name on the device, scanning a bar code corresponding to a traveler, sensing a radio-frequency identification corresponding to a traveler, and sensing a presence of a traveler using a global positioning system location indication.

12. A system to track a plurality of travelers during a trip, comprising:
a main database comprising a trip file corresponding to the trip, the trip file including traveler data corresponding to the plurality of travelers;
a portable database including the trip file; and
a mobile handheld device to physically travel with the plurality of travelers on the trip, the mobile handheld device being in communication with the portable database and being configured to:
access the trip file;
check-in the plurality of travelers by receiving an input to mark a traveler-present indicator as present for each of the plurality of travelers that is physically present;
determine if any of the plurality of travelers is missing by comparing the traveler data of the trip file and the marked traveler-present-indicators of each of the plurality of travelers that are physically present; and
check-out the plurality of travelers by receiving an input to unmark the traveler-present-indicator for each of the checked-in plurality of travelers that is no longer physically present.

13. The system of claim 12, wherein the portable database is contained within the mobile handheld device.

14. The system of claim 13, wherein the portable database synchronizes with the main database.

15. The system of claim 12, wherein the portable database and the main database form a single database.

16. The system of claim 12, wherein the main database is accessible via the Internet.

17. The system of claim 12, wherein the mobile handheld device is a smartphone.

18. The system of claim 12, wherein the check-in of the plurality of travelers and the check-out of the plurality of travelers is further by at least one member of the group consisting of touching on a traveler's name on the device, scanning a bar code corresponding to a traveler, sensing a radio-frequency identification corresponding to a traveler, and sensing a presence of a traveler using a global positioning system location indication.

19. The system of claim 12, wherein the traveler data corresponding to the plurality of travelers comprises traveler medical data, and wherein the mobile handheld device is further configured to display the traveler medical data.

20. The system of claim 12, wherein the traveler data corresponding to the plurality of travelers comprises traveler special needs data, and wherein the mobile handheld device is further configured to display the traveler special needs data.
